(19) United States
(12) Patent Application Publication
(10) Pub. No.: US 2009/0099743 A1
(43) Pub. Date: Apr. 16, 2009

(54) Control apparatus and control method for automatic transmission

(75) Inventors: Ayumu Sagawa, Toyota-shi (JP); Koji Oshima, Nagoya-shi (JP)

Correspondence Address: OLIFF & BERRIDGE, PLC, P.O. BOX 320850, ALEXANDRIA, VA, 22320-4850, US

(73) Assignee: TOYOTA JIDOSHA KABUSHIKI KAISHA, TOYOTA-SHI (JP)

(21) Appl. No.: 12/285,611

(22) Filed: Oct. 9, 2008

(30) Foreign Application Priority Data
Oct. 16, 2007 (JP) 2007-269304

(51) Int. Cl. B60W 10/10; G06F 17/00

(52) U.S. Cl. 701/55

(57) ABSTRACT

An ECU executes a program including a step of down shifting by disengaging a B3 brake as well as reducing engagement force of a C2 clutch and then engaging a C1 clutch and a B1 brake, or disengaging the B1 brake as well as reducing the engagement force of the C2 clutch and then engaging the C1 clutch and the B3 brake when an output torque of an engine is equal to or larger than a threshold value, and a step of down shifting by disengaging the B3 brake as well as engaging the C1 clutch and then disengaging the C2 clutch while engaging the B1 brake, or disengaging the B1 brake while engaging the B3 brake and then disengaging the C2 clutch while engaging the C1 clutch when the output torque of the engine is smaller than the threshold value.

This nonprovisional application is based on Japanese Patent Application No. 2007-269304 filed on Oct. 16, 2007, with the Japan Patent Office, the entire contents of which are hereby incorporated by reference.

### BACKGROUND OF THE INVENTION

1. Field of the Invention

The present invention relates to a control apparatus and a control method for an automatic transmission, particularly to a technique for performing a shift by bringing two friction engagement elements from an engaged state to a disengaged state and bringing other two friction engagement elements from the disengaged state to the engaged state.

2. Description of the Background Art

Conventionally, there is a known automatic transmission for performing a shift by changing a combination between engaged friction engagement elements among engagement elements such as a clutch and a brake. In such an automatic transmission, there is a case of requiring a shift from a gear implemented by engaging any two of friction engagement elements among a plurality of friction engagement elements to a gear implemented by engaging different two friction engagement elements.

Japanese Patent Laying-Open No. 2007-100927 discloses a control apparatus for an automatic transmission where a gear of a first gear ratio is implemented in a case where a first frictional engagement element and a second frictional engagement element are in an engaged state and a third frictional engagement element and a fourth frictional engagement element are in a disengaged state, and a gear of a second gear ratio is implemented in a case where the first frictional engagement element and the second frictional engagement element are in the disengaged state and the third frictional engagement element and the fourth frictional engagement element are in the engaged state. This control apparatus includes a first controller for controlling the first frictional engagement element and the second frictional engagement element so that the first frictional engagement element and the second frictional engagement element enter the disengaged state from a state where the gear of the first gear ratio is implemented, and a second controller for controlling the third frictional engagement element and the fourth frictional engagement element so that engagement of the third frictional engagement element and the fourth frictional engagement element is started to implement the gear of the second gear ratio after at least one of the first frictional engagement element and the second frictional engagement element completely enters the disengaged state.

According to the control apparatus for the automatic transmission described in Japanese Patent Laying-Open No. 2007-100927, the first frictional engagement element and the second frictional engagement element enter the disengaged state from the state where the gear of the first gear ratio is implemented. After at least one of the first frictional engagement element and the second frictional engagement element completely enters the disengaged state (neither the engaged nor slipped state), the engagement of the third frictional engagement element and the fourth frictional engagement element is started so as to implement the gear of the second gear ratio. Thereby, when performing a shift from the first to second gear ratio (for example, a down shift), by once bringing the automatic transmission to a neutral state, the shift can be performed while increasing the input shaft revolution number (engine speed). Here, since at least one of the first frictional engagement element and the second frictional engagement element is completely disengaged, the increase in the input shaft revolution number is not suppressed. Therefore, the input shaft revolution number can be quickly increased to the synchronous revolution number of the gear of the second gear ratio. As a result, it is possible to further shorten the time required for the shift.

However, when the automatic transmission once enters the neutral state during the shift as in the control apparatus described in Japanese Patent Laying-Open No. 2007-100927, the time required for increasing the input shaft revolution number (speed) of the automatic transmission to the synchronous revolution number of a gear of a target gear ratio may be extended in a case where the input shaft revolution number of the automatic transmission is not easily increased. Since output torque of an engine is decreased under an environment where atmosphere density (atmosphere pressure) is low such as highland, the input shaft revolution number of the automatic transmission is not easily increased. When the time required for increasing the input shaft revolution number of the automatic transmission to the synchronous revolution number of the gear of the target gear ratio is extended, progress of the shift is delayed. In this case, the neutral state is extended. As a result, the time for making drive force of a vehicle zero is extended.

### SUMMARY OF THE INVENTION

An object of the present invention is to shorten the time for making drive force of a vehicle zero during a shift.

A control apparatus for an automatic transmission according to a first invention is a control apparatus for an automatic transmission connected to a power source where a gear of a first gear ratio is implemented by engaging a first engagement element and a second engagement element, a gear of a second gear ratio is implemented by engaging the second engagement element and a third engagement element, and a gear of a third gear ratio is implemented by engaging the third engagement element and a fourth engagement element. This control apparatus includes a determiner to determine whether or not a shift from the gear of the third gear ratio to the gear of the first gear ratio is to be performed, a controller to control the automatic transmission so as to perform the shift from the gear of the third gear ratio to the gear of the first gear ratio by disengaging the fourth engagement element and the third engagement element and engaging the second engagement element and the first engagement element in a case where the shift from the gear of the third gear ratio to the gear of the first gear ratio is determined to be performed, and a detector to detect output torque of the power source. The controller disengages at least one of the fourth engagement element and the third engagement element and then engages the second engagement element and the first engagement element in a case where the output torque of the power source is larger than a threshold value, and disengages the fourth engagement element while engaging the second engagement element and then disengages the third engagement element while engaging the first engagement element in a case where the output torque of the power source is smaller than the threshold value.

According to this configuration, the shift from the gear of the third gear ratio to the gear of the first gear ratio is performed by disengaging the fourth engagement element and the third engagement element and engaging the second engagement element and the first engagement element. In the case where the output torque of the power source is larger than the threshold value, the shift from the gear of the third gear ratio to the gear of the first gear ratio is performed by disengaging at least one of the fourth engagement element and the third engagement element and then engaging the second engagement element and the first engagement element. Thereby, the automatic transmission can be brought to a neutral state during the shift. Therefore, the input shaft revolution number of the automatic transmission can be quickly increased. As a result, it is possible to shorten the time required for increasing the input shaft revolution number to the synchronous revolution number, that is, the time required for the shift. Meanwhile, when the output torque of the power source is small, an increasing rate of the input shaft revolution number is lowered. In this case, the time required for the shift may be extended. Then, in the case where the output torque of the power source is smaller than the threshold value, the shift from the gear of the third gear ratio to the gear of the first gear ratio is performed by disengaging the fourth engagement element while engaging the second engagement element and then disengaging the third engagement element while engaging the first engagement element. Thereby, while continuously outputting the drive force from the automatic transmission, the shift from the gear of the third gear ratio to the gear of the first gear ratio can be performed. Therefore, it is possible to shorten the time when the drive force of the vehicle is zero during the shift.

Preferably, the controller controls the automatic transmission so as to start performing the shift from the gear of the third gear ratio to the gear of the first gear ratio when a predetermined time passes after the shift from the gear of the third gear ratio to the gear of the first gear ratio is determined to be performed.

According to this configuration, when the predetermined time passes after the shift from the gear of the third gear ratio to the gear of the first gear ratio is determined to be performed, the shift from the gear of the third gear ratio to the gear of the first gear ratio is started. Thereby, in the case of an operation state where a shift other than the shift from the gear of the third gear ratio to the gear of the first gear ratio is to be performed within a time range from the determination of the shift to the start of the shift, the shift other than the shift from the gear of the third gear ratio to the gear of the first gear ratio can be performed. Therefore, the shift suitable for the operation state can be quickly performed. As a result, it is possible shorten the time when the drive force of the vehicle is zero.

Further preferably, in the case where the output torque of the power source is larger than the threshold value, the controller disengages the fourth engagement element, then engages the second engagement element, and after the second engagement element is engaged, disengages the third engagement element as well as engages the first engagement element.

According to this configuration, the fourth engagement element is disengaged and then the second engagement element is engaged. Thereby, within a time range from the disengagement of the fourth engagement element to the engagement of the second engagement element, the automatic transmission can be brought to the neutral state. After the second engagement element is engaged, the third engagement element is disengaged as well as the first engagement element is engaged. Thereby, the shift from the gear of the third gear ratio to the gear of the first gear ratio can be completed.

Further preferably, in the case where the output torque of the power source is larger than the threshold value, the controller disengages the fourth engagement element as well as reduces engagement force of the third engagement element, then engages the second engagement element, and after the second engagement element is engaged, disengages the third engagement element as well as engages the first engagement element in accordance with the timing when the revolution number of an input shaft of the automatic transmission is the same as the synchronous revolution number of the input shaft of the automatic transmission in the gear of the first gear ratio.

According to this configuration, the fourth engagement element is disengaged as well as the engagement force of the third engagement element is reduced and then the second engagement element is engaged. Within a time range from the disengagement of the fourth engagement element to the engagement of the second engagement element, the automatic transmission can be brought to the neutral state. When the third engagement element is disengaged later, the third engagement element can be quickly disengaged. After the second engagement element is engaged, the third engagement element is disengaged as well as the first engagement element is engaged in accordance with the timing when the revolution number of the input shaft of the automatic transmission is the same as the synchronous revolution number of the input shaft of the automatic transmission in the gear of the first gear ratio. Thereby, the shift from the gear of the third gear ratio to the gear of the first gear ratio can be completed.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic configuration diagram showing a vehicle.

FIG. 2 is a diagram showing a planetary gear unit.

FIG. 3 is a working table.

FIG. 4 is a diagram showing an oil hydraulic circuit.

FIG. 5 is a function block diagram of an ECU.

FIG. 6 is a timing chart (1) showing transition of oil pressure supplied to a brake and a clutch.

FIG. 7 is a map used for setting the torque down amount.

FIG. 8 is a timing chart (2) showing the transition of the oil pressure supplied to the brake and the clutch.

FIG. 9 is a flowchart showing a control structure of a program to be executed by the ECU.

FIG. 10 is a timing chart showing drive force during a shift.

### DESCRIPTION OF THE PREFERRED EMBODIMENTS

Hereinafter, an embodiment of the present invention will be described with reference to the drawings. In the following description, the same parts are given the same reference numerals. Names and functions thereof are the same. Therefore, a detailed description thereof will not be repeated.

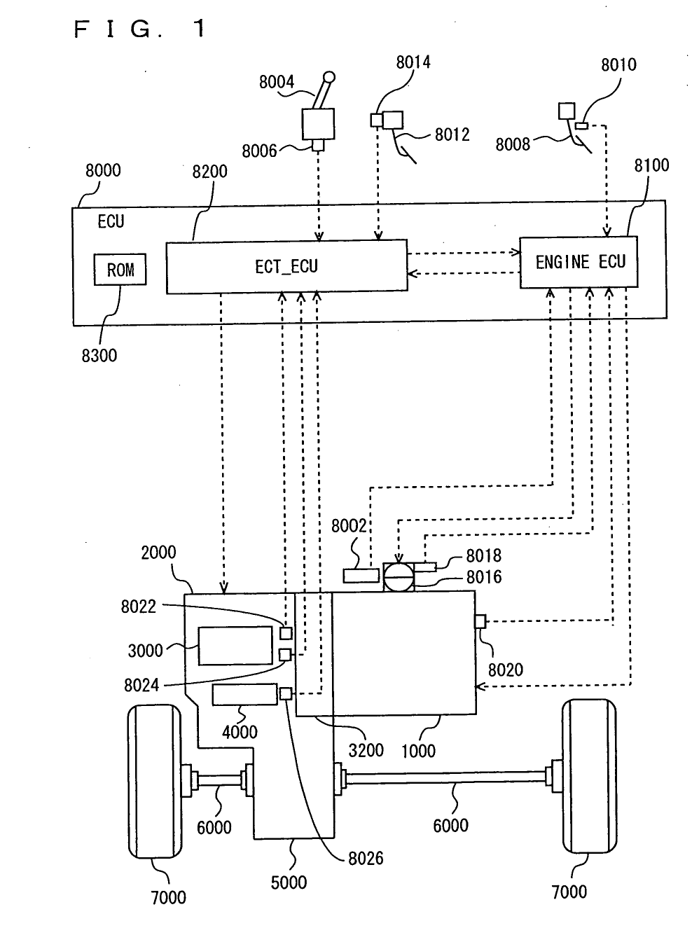

With reference to FIG. 1, a vehicle with a control apparatus according to the embodiment of the present invention installed will be described. This vehicle is a FF (Front engine Front drive) vehicle. It should be noted that the vehicle may be a vehicle other than the FF vehicle.

The vehicle includes an engine 1000, an automatic transmission 2000, a planetary gear unit 3000 forming a part of automatic transmission 2000, an oil hydraulic circuit 4000 forming a part of automatic transmission 2000, a differential gear 5000, a drive shaft 6000, front wheels 7000, and an ECU (Electronic Control Unit) 8000. The control apparatus according to the present embodiment is realized by for example executing a program stored in a ROM (Read Only Memory) 8300 of ECU 8000. It should be noted that the program to be executed by ECU 8000 may be stored in a recording medium such as a CD (Compact Disc) and a DVD (Digital Versatile Disc) and then distributed on the market.

Engine 1000 is an internal combustion engine for burning a mixture of a fuel injected from an injector (not shown) and the air inside a combustion chamber of a cylinder. A piston in the cylinder is pushed down by the combustion and a crankshaft is rotated. It should be noted that a motor may be used as a power source in addition to engine 1000.

Automatic transmission 2000 is coupled to engine 1000 via a torque converter 3200. Automatic transmission 2000 performs a shift of the revolution number of the crankshaft to a desired revolution number by forming a desired gear.

An output gear of automatic transmission 2000 is meshed with differential gear 5000. Drive shaft 6000 is coupled to differential gear 5000 by spline-fitting or the like. Motive power is transmitted to the left and right front wheels 7000 via drive shaft 6000.

An airflow meter 8002, a position switch 8006 of a shift lever 8004, an accelerator pedal position sensor 8010 of an accelerator pedal 8008, a pedal pressing force sensor 8014 of a brake pedal 8012, a throttle opening position sensor 8018 of an electronic throttle valve 8016, an engine speed sensor 8020, an input shaft speed sensor 8022, an output shaft speed sensor 8024, and an oil temperature sensor 8026 are connected to ECU 8000 via a harness and the like.

Airflow meter 8002 detects the air amount to be taken in engine 1000 and transmits a signal representing a detection result to ECU 8000. A position of shift lever 8004 is detected by position switch 8006, and a signal representing a detection result is transmitted to ECU 8000. A gear of automatic transmission 2000 is automatically implemented corresponding to the position of shift lever 8004. A driver may select a manual shift mode capable of selecting a gear arbitrarily in accordance with operations of the driver.

Accelerator pedal position sensor 8010 detects a position of accelerator pedal 8008 and transmits a signal representing a detection result to ECU 8000. Pedal pressing force sensor 8014 detects pedal pressing force of brake pedal 8012 (force generated by pressing brake pedal 8012 of the driver) and transmits a signal representing a detection result to ECU 8000.

Throttle opening position sensor 8018 detects an opening position of electronic throttle valve 8016 adjusted by an actuator and transmits a signal representing a detection result to ECU 8000. The air amount to be taken in engine 1000 (output of engine 1000) is adjusted by electronic throttle valve 8016.

It should be noted that the air amount to be taken in engine 1000 may be adjusted by changing the lift amount or an opening/closing phase of an intake valve (not shown) or an exhaust valve (not shown) instead of or in addition to electronic throttle valve 8016.

Engine speed sensor 8020 detects the revolution number (speed) of an output shaft (crankshaft) of engine 1000 and transmits a signal representing a detection result to ECU 8000. Input shaft speed sensor 8022 detects the input shaft revolution number NI of automatic transmission 2000 (a turbine revolution number NT of torque converter 3200) and transmits a signal representing a detection result to ECU 8000. Output shaft speed sensor 8024 detects an output shaft revolution number NO of automatic transmission 2000 and transmits a signal representing a detection result to ECU 8000. Vehicle speed is calculated (detected) from output shaft revolution number NO.

Oil temperature sensor 8026 detects a temperature (an oil temperature) of oil used for operating and lubricating automatic transmission 2000 (ATF: Automatic Transmission Fluid) and transmits a signal representing a detection result to ECU 8000.

ECU 8000 controls devices so that the vehicle is in a desired traveling state based on the signals transmitted from airflow meter 8002, position switch 8006, accelerator pedal position sensor 8010, pedal pressing force sensor 8014, throttle opening position sensor 8018, engine speed sensor 8020, input shaft speed sensor 8022, output shaft speed sensor 8024, oil temperature sensor 8026 and the like, a map and the program stored in ROM 8300.

In the present embodiment, ECU 8000 controls automatic transmission 2000 so that any of first to sixth gears is implemented in a case where a D (drive) range is selected as a shift range of automatic transmission 2000 by placing shift lever 8004 at a D (drive) position. Since any of the first to sixth gears is implemented, automatic transmission 2000 is capable of transmitting drive force to front wheels 7000. It should be noted that a gear of higher speed than the sixth gear, that is, a seventh gear or a eighth gear may be implemented in the D range. A gear to be implemented is determined based on a shift map preliminarily made by an experiment or the like taking the vehicle speed and the accelerator pedal position as parameters.

As shown in FIG. 1, ECU 8000 includes an engine ECU 8100 for controlling engine 1000, and an ECT (Electronic Controlled Transmission)_ECU 8200 for controlling automatic transmission 2000.

Engine ECU 8100 and ECT_ECU 8200 are formed so as to send and receive signals to and from each other. In the present embodiment, a signal representing the accelerator pedal position, a signal representing an output torque TEKL calculated from the intake air amount and the like are sent from engine ECU 8100 to ECT_ECU 8200. Signals representing the torque demand amount, the torque down amount, the torque up amount and the like determined as torque to be output by engine 1000 are sent from ECT_ECU 8200 to engine ECU 8100.

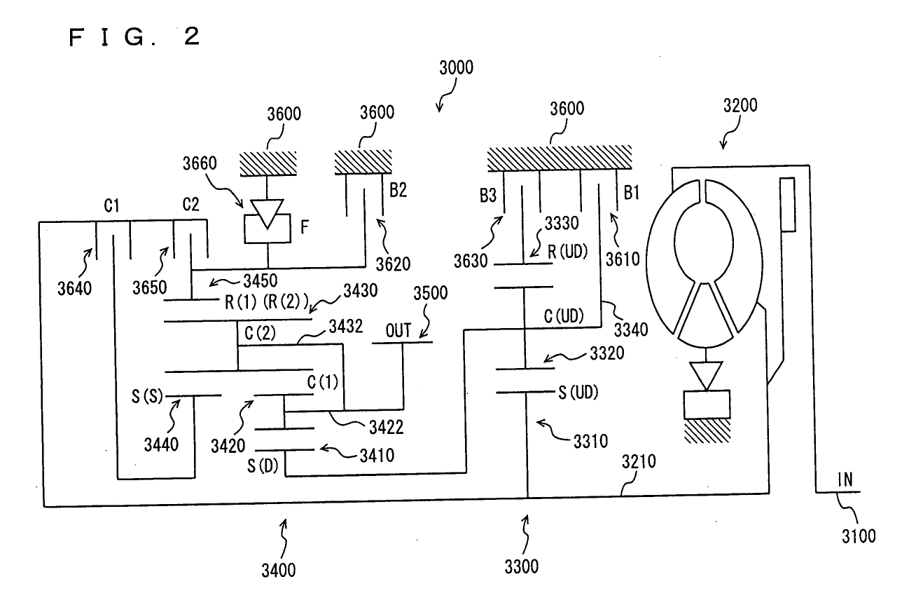

With reference to FIG. 2, planetary gear unit 3000 will be described. Planetary gear unit. 3000 is connected to torque converter 3200 having an input shaft 3100 coupled to the crankshaft. Planetary gear unit 3000 includes a first set of planetary gear mechanism 3300, a second set of planetary gear mechanism 3400, an output gear 3500, B1, B2 and B3 brakes 3610, 3620 and 3630 fixed to a gear case 3600, C1 and C2 clutches 3640 and 3650, and a one-way clutch F 3660.

First set 3300 is a single pinion type planetary gear mechanism. First set 3300 includes a sun gear S (UD) 3310, a pinion gear 3320, a ring gear R (UD) 3330, and a carrier C (UD) 3340.

Sun gear S (UD) 3310 is coupled to an output shaft 3210 of torque converter 3200. Pinion gear 3320 is rotatably supported on carrier C (UD) 3340. Pinion gear 3320 is meshed with sun gear S (UD) 3310 and ring gear R (UD) 3330.

Ring gear R (UD) 3330 is fixed to gear case 3600 by B3 brake 3630. Carrier C (UD) 3340 is fixed to gear case 3600 by B1 brake 3610.

Second set 3400 is a Ravigneaux type planetary gear mechanism. Second set 3400 includes a sun gear S (D) 3410, a short pinion gear 3420, a carrier C (1) 3422, a long pinion gear 3430, a carrier C (2) 3432, a sun gear S (S) 3440, and a ring gear R (1) (R (2)) 3450.

Sun gear S (D) 3410 is coupled to carrier C (UD) 3340. Short pinion gear 3420 is rotatably supported on carrier C (1) 3422. Short pinion gear 3420 is meshed with sun gear S (D) 3410 and long pinion gear 3430. Carrier C (1) 3422 is coupled to output gear 3500.

Long pinion gear 3430 is rotatably supported on carrier C (2) 3432. Long pinion gear 3430 is meshed with short pinion gear 3420, sun gear S (S) 3440 and ring gear R (1) (R (2)) 3450. Carrier C (2) 3432 is coupled to output gear 3500.

Sun gear S (S) 3440 is coupled to output shaft 3210 of torque converter 3200 by C1 clutch 3640. Ring gear R (1) (R (2)) 3450 is fixed to gear case 3600 by B2 brake 3620 and coupled to output shaft 3210 of torque converter 3200 by C2 clutch 3650. Ring gear R (1) (R (2)) 3450 is coupled to one-way clutch F 3660 and disabled in rotation during drive in the first gear.

One-way clutch F 3660 is provided in parallel with B2 brake 3620. That is, an outer race of one-way clutch F 3660 is fixed to gear case 3600, and an inner race is coupled to ring gear R (1) (R (2)) 3450 via a rotation shaft.

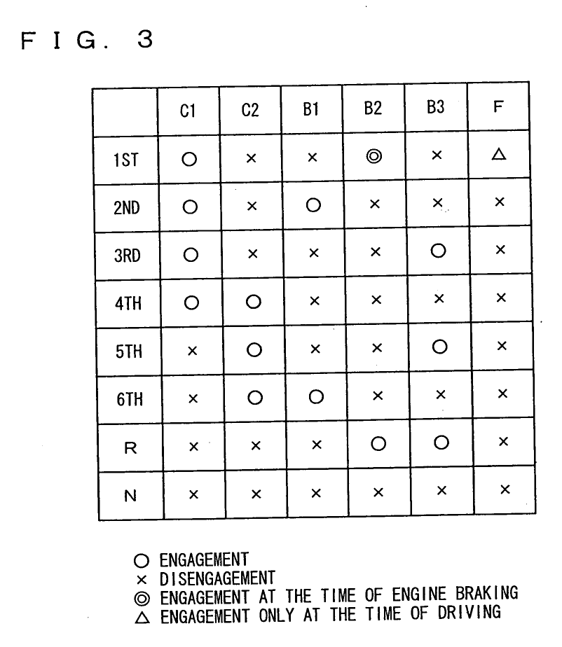

FIG. 3 shows a table illustrating a relationship between the shift gears and working states of the clutches and the brakes. First to sixth forward gears and a reverse gear are implemented by operating the brakes and the clutches with combinations shown in this table.

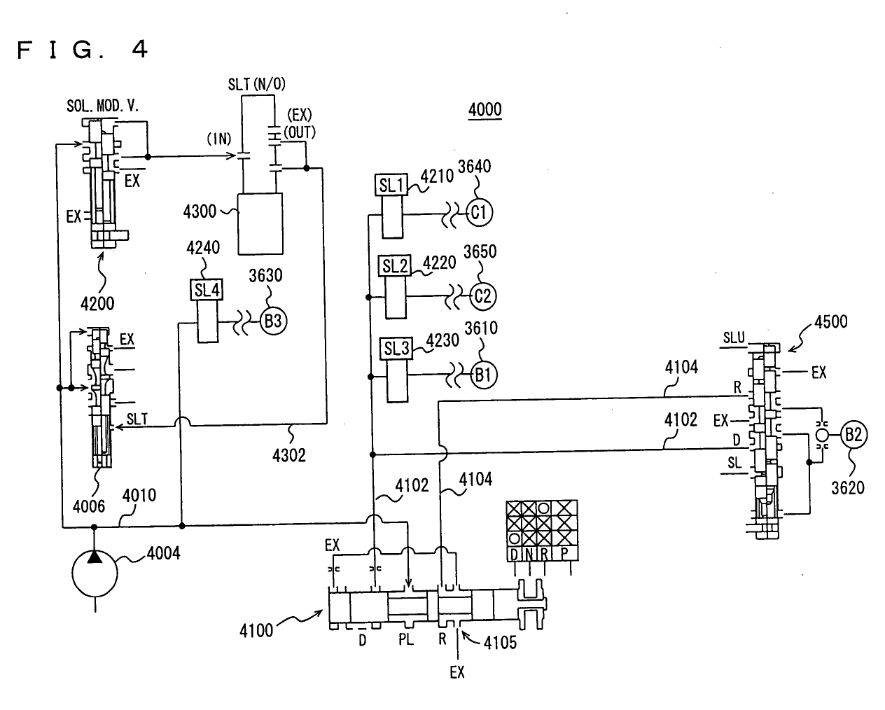

With reference to FIG. 4, a principal portion of oil hydraulic circuit 4000 will be described. It should be noted that oil hydraulic circuit 4000 is not limited to the one described below.

Oil hydraulic circuit 4000 includes an oil pump 4004, a primary regulator valve 4006, a manual valve 4100, a solenoid modulator valve 4200, an SL1 linear solenoid (hereinafter, indicated as SL (1)) 4210, an SL2 linear solenoid (hereinafter, indicated as SL (2)) 4220, an SL3 linear solenoid (hereinafter, indicated as SL (3)) 4230, an SL4 linear solenoid (hereinafter, indicated as SL (4)) 4240, an SLT linear solenoid (hereinafter, indicated as SLT) 4300, and a B2 control valve 4500.

Oil pump 4004 is coupled to the crankshaft of engine 1000. Oil pump 4004 is driven by rotation of the crankshaft so as to generate oil pressure. The oil pressure generated in oil pump 4004 is adjusted by primary regulator valve 4006 so as to generate line pressure.

Primary regulator valve 4006 is operated taking throttle pressure adjusted by SLT 4300 as pilot pressure. The line pressure is supplied to manual valve 4100 via a line pressure oil channel 4010.

Manual valve 4100 includes a drain port 4105. The oil pressure of a D range pressure oil channel 4102 and an R range pressure oil channel 4104 is discharged from drain port 4105. In a case where a spool of manual valve 4100 is at the D position, line pressure oil channel 4010 communicates with D range pressure oil channel 4102. Therefore, the oil pressure is supplied to D range pressure oil channel 4102. Here, R range pressure oil channel 4104 communicates with drain port 4105. Therefore, R range pressure of R range pressure oil channel 4104 is discharged from drain port 4105.

In a case where the spool of manual valve 4100 is at the R position, line pressure oil channel 4010 communicates with R range pressure oil channel 4104. Therefore, the oil pressure is supplied to R range pressure oil channel 401. Here, D range pressure oil channel 4102 communicates with drain port 4105. Therefore, D range pressure of D range pressure oil channel 4102 is discharged from drain port 4105.

In a case where the spool of manual valve 4100 is at the N position, both D range pressure oil channel 4102 and R range pressure oil channel 4104 communicate with drain port 4105. Therefore, the D range pressure of D range pressure oil channel 4102 and the R range pressure of R range pressure oil channel 4104 are discharged from drain port 4105.

The oil pressure supplied to D range pressure oil channel 4102 is eventually supplied to B1 brake 3610, B2 brake 3620, C1 clutch 3640 and C2 clutch 3650. The oil pressure supplied to R range pressure oil channel 4104 is eventually supplied to B2 brake 3620.

Solenoid modulator valve 4200 adjusts the line pressure at a constant level, and the oil pressure adjusted by solenoid modulator valve 4200 (solenoid modulator pressure) is supplied to SLT 4300.

SL (1) 4210 adjusts the oil pressure supplied to C1 clutch 3640. SL (2) 4220 adjusts the oil pressure supplied to C2 clutch 3650. SL (3) 4230 adjusts the oil pressure supplied to B1 brake 3610. SL (4) 4240 adjusts the oil pressure supplied to B3 brake 3630.

SLT 4300 adjusts the solenoid modulator pressure in accordance with a control signal from ECU 8000 based on the accelerator pedal position detected by accelerator pedal position sensor 8010 so as to generate the throttle pressure. The throttle pressure is supplied to primary regulator valve 4006 via SLT oil channel 4302. The throttle pressure is utilized as the pilot pressure of primary regulator valve 4006.

SL (1) 4210, SL (2) 4220, SL (3) 4230, SL (4) 4240, and SLT 4300 are controlled by the control signal sent from ECU 8000.

B2 control valve 4500 selectively supplies the oil pressure from one of D range pressure oil channel 4102 and R range pressure oil channel 4104 to B2 brake 3620. D range pressure oil channel 4102 and R range pressure oil channel 4104 are connected to B2 control valve 4500. B2 control valve 4500 is controlled by the oil pressure supplied from an SL solenoid valve (not shown) and an SLU solenoid valve (not shown) and the urge of a spring.

In a case where the SL solenoid valve is OFF and the SLU solenoid valve is ON, B2 control valve 4500 attains the left side state of FIG. 4. In this case, B2 brake 3620 is supplied with oil pressure having the D range pressure adjusted taking the oil pressure supplied from the SLU solenoid valve as the pilot pressure.

In a case where the SL solenoid valve is ON and the SLU solenoid valve is OFF, B2 control valve 4500 attains the right side state of FIG. 4. In this case, B2 brake 3620 is supplied with the R range pressure.

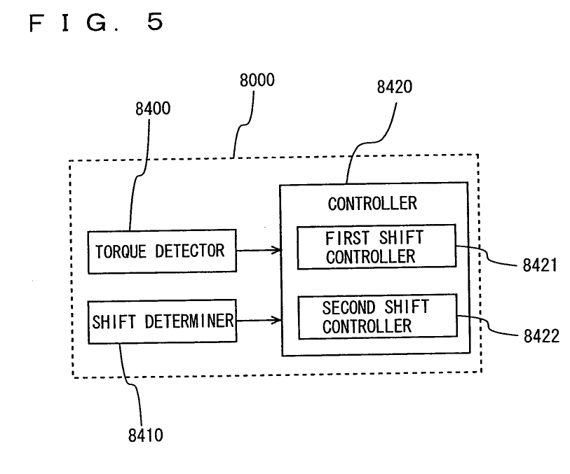

With reference to FIG. 5, functions of ECU 8000 will be described. It should be noted that the functions of ECU 8000 described below may be realized by either hardware or software.

ECU 8000 is provided with a torque detector 8400, a shift determiner 8410, and a controller 8420. Controller 8420 includes a first shift controller 8421 and a second shift controller 8422.

Torque detector 8400 detects (calculates) output torque TEKL of engine 1000. Output toque TEKL is calculated in accordance with a map taking the intake air amount detected by airflow meter 8002 and an engine revolution number NE as the parameters. It should be noted that a generally known technique may be utilized for a method of calculating output torque TEKL of engine 1000. Therefore, a further detailed description will not be repeated here.

Shift determiner 8410 determines whether or not a down shift from the fifth gear to the second gear or from the sixth gear to the third gear is to be performed. The down shift is determined in accordance with the shift map taking for example the vehicle speed and the accelerator pedal position as the parameters.

In a case where the down shift is performed from the fifth gear implemented by engaging B3 brake 3630 and C2 clutch 3650 to the second gear implemented by engaging C1 clutch 3640 and B1 brake 3610, controller 8420 performs a control so as to disengage B3 brake 3630 and C2 clutch 3650 and engage C1 clutch 3640 and B1 brake 3610.

In a case where the down shift is performed from the sixth gear implemented by engaging B1 brake 3610 and C2 clutch 3650 to the third gear implemented by engaging C1 clutch 3640 and B3 brake 3630, controller 8420 performs a control so as to disengage B13 brake 3610 and C2 clutch 3650 and engage C1 clutch 3640 and B3 brake 3630.

When a predetermined standby time TS passes after the down shift from the fifth gear to the second gear or the sixth gear to the third gear is determined to be performed, controller 8420 starts the down shift from the fifth gear to the second gear or the sixth gear to the third gear.

In a case where output torque TEKL of engine 1000 is equal to or larger than a threshold value TES, first shift controller 8421 of controller 8420 performs the down shift from the fifth gear to the second gear by completely disengages B3 brake 3630 as well as reducing engagement force of C2 clutch 3650 and then engaging C1 clutch 3640 and B1 brake 3610.

In the case where output torque TEKL of engine 1000 is equal to or larger than threshold value TES, first shift controller 8421 performs the down shift from the sixth gear to the third gear by completely disengaging B1 brake 3610 as well as reducing the engagement force of C2 clutch 3650 and then engaging C1 clutch 3640 and B3 brake 3630.

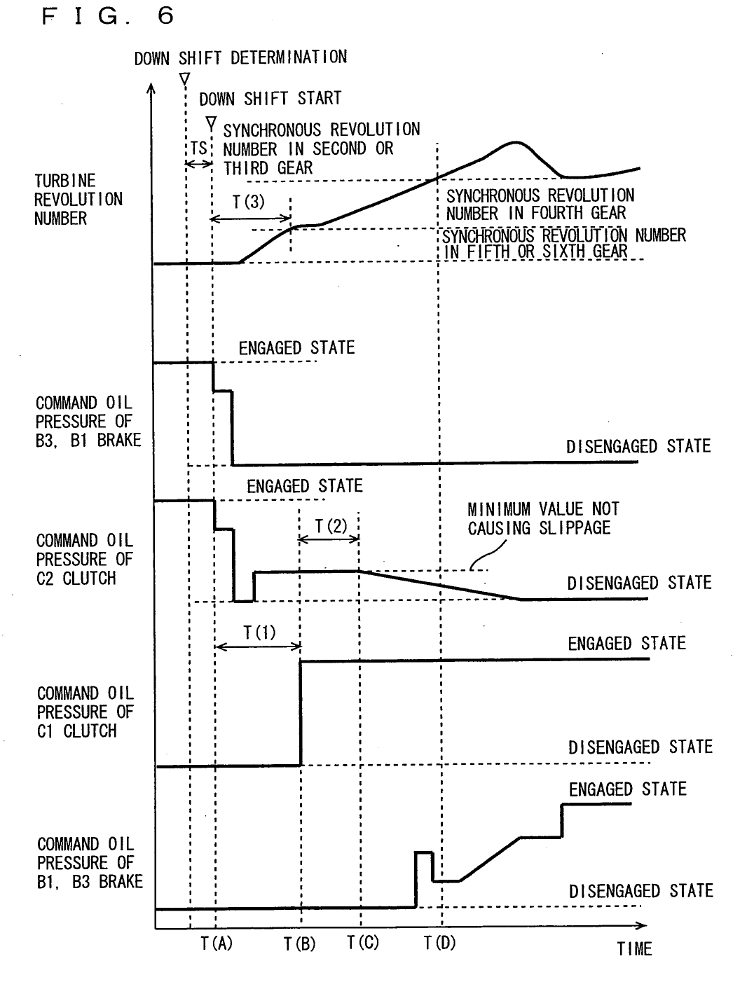

With reference to FIG. 6, the down shift from the fifth gear to the second gear performed in the case where output torque TEKL of engine 1000 is equal to or larger than threshold value TES will be described in detail.

After the down shift is started at a time T (A), B3 brake 3630 enters a disengaged state. The engagement force of C2 clutch 3650 (the oil pressure supplied to C2 clutch 3650) is reduced. C2 clutch 3650 is controlled so as to have minimum engagement force required for not causing slippage in C2 clutch 3650. In this state, B3 brake 3630 is completely disengaged. Therefore, automatic transmission 2000 is in a neutral state.

C1 clutch 3640 enters an engaged state at a time T (B) when a time T (1) passes after the start of the down shift. That is, after the disengagement of B3 brake 3630 is completed and the engagement force of C2 clutch 3650 is reduced, C1 clutch 3640 enters the engaged state. Engagement pressure of C2 clutch 3650, that is, the engagement force is gradually decreased at a predetermined rate at a time T (C) when a time T (2) passes after that.

After that, the control is further performed so that B1 brake 3610 has the engagement force at a time T (D) when turbine revolution number NT of torque converter 3200, that is, input shaft revolution number NI of automatic transmission 2000 is synchronized with the synchronous revolution number calculated by multiplying output shaft revolution number NO by a gear ratio of the gear after the shift. For example, when a difference between turbine revolution number NT and the synchronous revolution number is smaller than a threshold value, the engagement of B1 brake 3610 is started.

The down shift from the sixth gear implemented by engaging B1 brake 3610 and C2 clutch 3650 to the third gear implemented by engaging C1 clutch 3640 and B3 brake 3630 is performed similarly to the down shift from the fifth gear to the second gear. That is, the down shift from the sixth gear to the third gear is performed in a similar mode to the down shift from the fifth gear to the second gear with a condition that B1 brake 3610 is replaced by B3 brake 3630.

During the down shift from the fifth gear to the second gear or from the sixth gear to the third gear, as shown in FIG. 6, an ignition timing is retarded so that turbine revolution number NT is increased to the synchronous revolution number in the fourth gear at a time T (3) after the start of the down shift. Thereby, the output torque of engine 1000 is decreased. The time T (3) is desirably the same or the substantially same as the time T (1). The synchronous revolution number in the fourth gear is calculated by multiplying output shaft revolution number NO by the gear ratio of the fourth gear.

The output torque is decreased by the torque down amount calculated based on output torque TEKL of engine 1000 calculated from the intake air amount detected by airflow meter 8002 and output shaft revolution number NO of automatic transmission 2000.

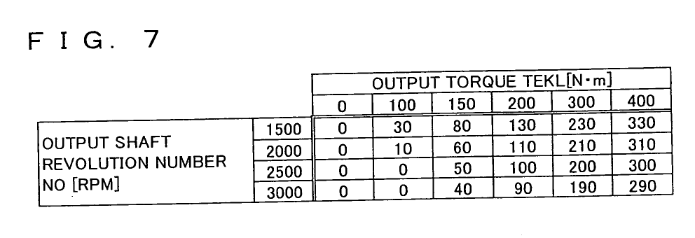

As shown in FIG. 7, the torque down amount is set in accordance with a map taking output torque TEKL calculated from the intake air amount and output shaft revolution number NO of automatic transmission 2000 as the parameters.

In principal, when output shaft revolution number NO is the same, the torque down amount is set so that a value determined by subtracting the set torque down amount from output torque TEKL calculated from the intake air amount is the same. Engine 1000 is controlled so as to output torque determined by subtracting the torque down amount from output torque TEKL calculated from the intake air amount. That is, the output torque of engine 1000 is decreased to fixed torque determined for every output shaft revolution number NO. After the decrease in the output torque of engine 1000, when an inertia phase is started, the output torque of engine 1000 is gradually increased at a predetermined rate.

In a case where output torque TEKL of engine 1000 is smaller than threshold value TES, second shift controller 8422 of controller 8420 performs the down shift from the fifth gear to the second gear by disengaging B3 brake 3630 while engaging C1 clutch 3640 and then disengaging C2 clutch 3650 while engaging B1 brake 3610.

That is, during the down shift from the fifth gear to the second gear, the fourth gear is once implemented. It should be noted that instead of performing the down shift from the fifth gear to the second gear via the fourth gear, the down shift may be performed from the fifth gear to the second gear via the third gear.

In the case where output torque TEKL of engine 1000 is smaller than threshold value TES, second shift controller 8422 performs the down shift from the sixth gear to the third gear by disengaging B1 brake 3610 while engaging B3 brake 3630 and then disengaging C2 clutch 3650 while engaging C1 clutch 3640.

That is, during the down shift from the sixth gear to the third gear, the fifth gear is once implemented. It should be noted that instead of performing the down shift from the sixth gear to the third gear via the fifth gear, the down shift may be performed from the sixth gear to the third gear via the fourth gear.

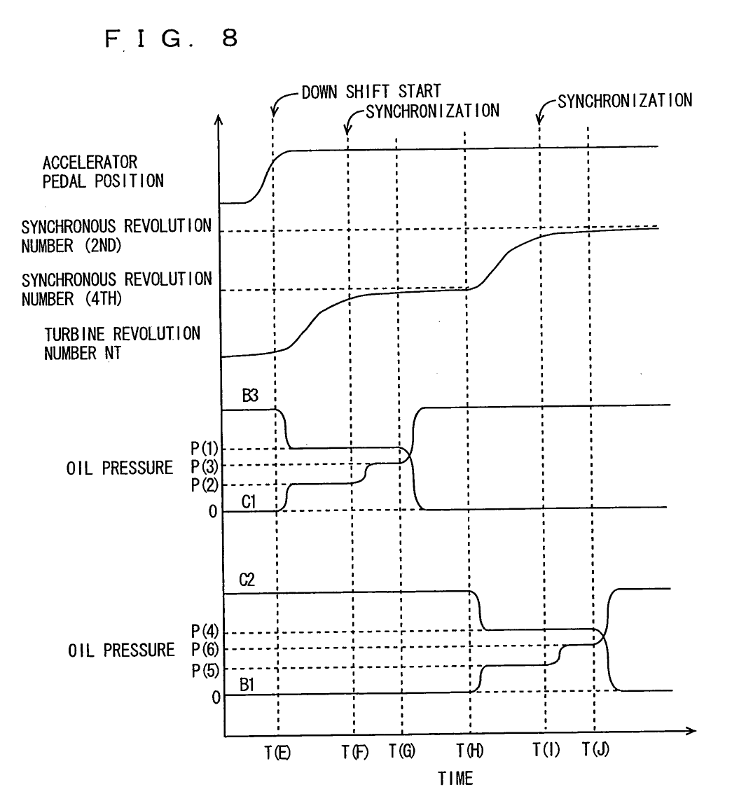

With reference to FIG. 8, the down shift from the fifth gear to the second gear performed in the case where output torque TEKL of engine 1000 is smaller than threshold value TES will be described in detail.

When the down shift is started, the oil pressure to be supplied to B3 brake 3630 is reduced to oil pressure P (1) as shown in FIG. 8. The oil pressure to be supplied to C1 clutch 3640 is increased to oil pressure P (2).

When a difference between turbine revolution number NT and the synchronous revolution number in the fourth gear is equal to or smaller than a predetermined difference, the oil pressure to be supplied to C1 clutch 3640 is increased to oil pressure P (3) as shown in a time T (F) in FIG. 8. Thereby, the down shift is further progressed.

As shown in a time T (G) in FIG. 8, when the state that the difference between turbine revolution number NT and the synchronous revolution number in the fourth gear is equal to or smaller than the predetermined difference continues for a predetermined time or longer, the oil pressure to be supplied to B3 brake 3630 is to be “zero”. The oil pressure to be supplied to C1 clutch 3640 is increased to the oil pressure for completely engaging C1 clutch 3640. In such a way, B3 brake 3630 is disengaged, while C1 clutch 3640 is engaged. As a result, the down shift from the fifth gear to the fourth gear is once performed.

Then, as shown in a time T (H) in FIG. 8, the oil pressure to be supplied to C2 clutch 3650 is reduced to oil pressure P (4). The oil pressure to be supplied to B1 brake 3610 is increased to oil pressure P (5).

When a difference between turbine revolution number NT and the synchronous revolution number in the second gear is equal to or smaller than a predetermined difference, the oil pressure to be supplied to B1 brake 3610 is increased to oil pressure P (6) as shown in a time T (I) in FIG. 8. Thereby, the down shift is further progressed.

As shown in a time T (J) in FIG. 8, when the state that the difference between turbine revolution number NT and the synchronous revolution number in the second gear is equal to or smaller than the predetermined difference continues for a predetermined time or longer, the oil pressure to be supplied to C2 clutch 3650 is to be “zero”. The oil pressure to be supplied to B1 brake 3610 is increased to the oil pressure for completely engaging B1 brake 3610. In such a way, C2 clutch 3650 is disengaged, while B1 brake 3610 is engaged. As a result, the down shift from the fourth gear to the second gear is performed.

The down shift from the sixth gear to the third gear is performed similarly to the down shift from the fifth gear to the second gear. That is, the down shift from the sixth gear to the third gear is performed in a similar mode to the down shift from the fifth gear to the second gear without the fact that the fifth gear is once implemented.

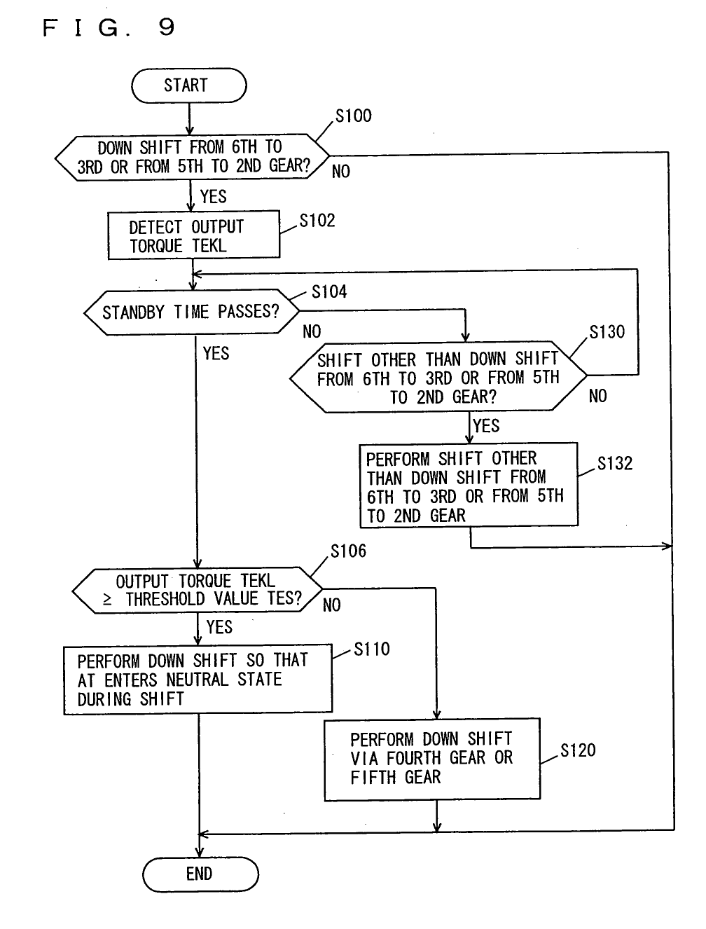

With reference to FIG. 9, a control structure of the program executed by ECU 8000 will be described. It should be noted that the program described below is repeatedly executed at a predetermined cycle.

In Step (hereinafter, Step will be abbreviated as S) 100, ECU 8000 determines whether or not the down shift from the fifth gear to the second gear or the down shift from the sixth gear to the third gear is to be performed. That is, ECU 8000 determines whether or not two friction engagement elements to be engaged before the shift and two friction engagement elements to be engaged after the shift are all different.

The down shift is determined based on the shift map taking the vehicle speed and the accelerator pedal position as the parameters or operations of shift lever 8004 by the driver. When the down shift is determined to be performed (YES in S100), the processing is moved to S102. When not (NO in S100), this processing is finished.

In S102, ECU 8000 detects (calculates) output torque TEKL of engine 1000.

In S104, ECU 8000 determines whether or not predetermined standby time TS passes after the down shift from the fifth gear to the second gear or the down shift from the sixth gear to the third gear is determined to be performed. When standby time TS passes (YES in S104), the processing is moved to S106. When not (NO in S104), the processing is moved to S130.

In S106, ECU 8000 determines whether or not output torque TEKL of engine 1000 is equal to or larger than threshold value TES. When output torque TEKL of engine 1000 is equal to or larger than threshold value TES (YES in S106), the processing is moved to S110. When not (NO in S106), the processing is moved to S120.

In S110, ECU 8000 performs the down shift from the fifth gear to the second gear or the down shift from the sixth gear to the third gear so that automatic transmission 2000 enters the neutral state during the down shift. More specifically, the down shift from the fifth gear to the second gear is performed by completely disengaging B3 brake 3630 as well as reducing the engagement force of C2 clutch 3650, and then engaging C1 clutch 3640 and B1 brake 3610. The down shift from the sixth gear to the third gear is performed by completely disengaging B1 brake 3610 as well as reducing the engagement force of C2 clutch 3650, and then engaging C1 clutch 3640 and B3 brake 3630.

In S120, ECU 8000 performs the down shift from the fifth gear to the second gear or the down shift from the sixth gear to the third gear via the fourth gear or the fifth gear. More specifically, the down shift from the fifth gear to the second gear is performed by disengaging B3 brake 3630 while engaging C1 clutch 3640, and then disengaging C2 clutch 3650 while engaging B1 brake 3610. The down shift from the sixth gear to the third gear is performed by disengaging B1 brake 3610 while engaging B3 brake 3630, and then disengaging C2 clutch 3650 while engaging C1 clutch 3640.

In S130, ECU 8000 determines whether or not a shift other than the down shift from the fifth gear to the second gear or the down shift from the sixth gear to the third gear is to be performed. In a case where the shift other than the down shift from the fifth gear to the second gear or the down shift from the sixth gear to the third gear is to be performed (YES in S130), the processing is moved to S132. When not (NO in S130), the processing is returned to S104.

In S132, ECU 8000 performs the shift other than the down shift from the fifth gear to the second gear or the down shift from the sixth gear to the third gear. After that, this processing is finished.

Actions of ECU 8000 in the present embodiment will be described based on the above structure and the flowchart.

For example, when the accelerator pedal position is radically changed so press down during traveling of the vehicle, the down shift from the fifth gear to the second gear or the down shift from the sixth gear to the third gear is determined to be performed (YES in S100).

When the down shift from the fifth gear to the second gear or the down shift from the sixth gear to the third gear is determined to be performed, output torque TEKL of engine 1000 is detected (S102).

Until the predetermined standby time passes after the down shift from the fifth gear to the second gear or the down shift from the sixth gear to the third gear is determined to be performed (NO in S104), whether or not the shift other than the down shift from the fifth gear to the second gear or the down shift from the sixth gear to the third gear is to be performed is determined (S130).

In the case where the shift other than the down shift from the fifth gear to the second gear or the down shift from the sixth gear to the third gear is to be performed (YES in S130), the shift other than the down shift from the fifth gear to the second gear or the down shift from the sixth gear to the third gear is performed (S132).

When the shift other than the down shift from the fifth gear to the second gear or the down shift from the sixth gear to the third gear is not determined to be performed (NO in S130) and then the standby time passes (YES in S104), whether or not output torque TEKL of engine 1000 is equal to or larger than threshold value TES is determined (S106).

When output torque TEKL of engine 1000 is equal to or larger than threshold value TES (YES in S106), the down shift from the fifth gear to the second gear or the down shift from the sixth gear to the third gear is performed so that automatic transmission 2000 enters the neutral state during the down shift (S110).

In this case, the down shift from the fifth gear to the second gear is performed by completely disengaging B3 brake 3630 as well as reducing the engagement force of C2 clutch 3650, and then engaging C1 clutch 3640 and B1 brake 3610. The down shift from the sixth gear to the third gear is performed by completely disengaging B1 brake 3610 as well as reducing the engagement force of C2 clutch 3650, and then engaging C1 clutch 3640 and B3 brake 3630. Thereby, automatic transmission 2000 can enter the neutral state during the down shift. Therefore, turbine revolution number NT, that is, input shaft revolution number NI of automatic transmission 2000 can be quickly increased. As a result, it is possible to quickly perform the down shift.

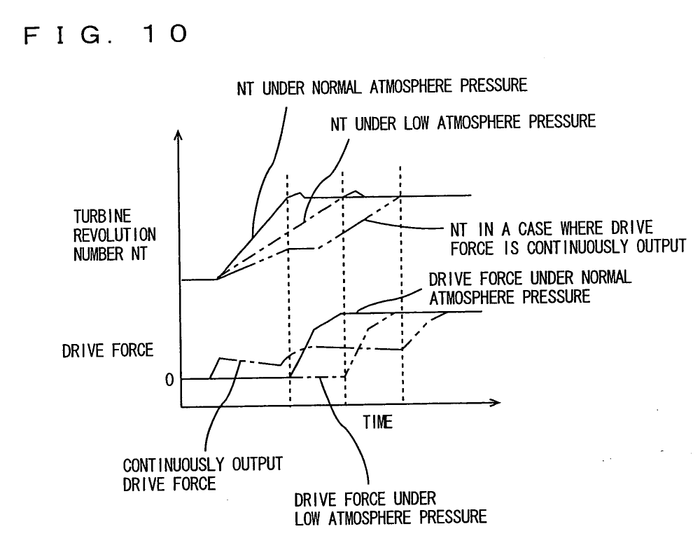

However, the output torque of engine 1000 is decreased under an environment where atmosphere density (atmosphere pressure) is low such as highland. Therefore, as shown by a single chain line in FIG. 10, turbine revolution number NT, that is, input shaft revolution number NI of automatic transmission 2000 is not easily increased in comparison to a case where the down shift is performed under normal atmosphere pressure (shown by a solid line). Consequently, the time required for increasing turbine revolution number NT to the synchronous revolution number of a target gear is extended. As a result, the time required for completing the down shift, that is, the time when automatic transmission 2000 is in the neutral state is extended.

When the time when automatic transmission 2000 is in the neutral state is extended, as shown by the single chain line in FIG. 10, the time when the drive force of the vehicle is “zero” is extended in comparison to a case where the down shift is performed under the normal atmosphere pressure (shown by the solid line). Therefore, the driver is given a sense of discomfort.

Then, when output torque TEKL of engine 1000 is smaller than threshold value TES (NO in S106), the down shift from the fifth gear to the second gear or the down shift from the sixth gear to the third gear is performed via the fourth gear or the fifth gear (S120).

In this case, the down shift from the fifth gear to the second gear is performed by disengaging B3 brake 3630 while engaging C1 clutch 3640, and then disengaging C2 clutch 3650 while engaging B1 brake 3610. The down shift from the sixth gear to the third gear is performed by disengaging B1 brake 3610 while engaging B3 brake 3630, and then disengaging C2 clutch 3650 while engaging C1 clutch 3640. Thereby, as shown by a double chain line in FIG. 10, the down shift can be performed while continuously outputting the drive force of the vehicle. Therefore, it is possible to reduce the sense of discomfort given to the driver.

As mentioned above, in the present embodiment, in a case where output torque TEKL of the engine is equal to or larger than threshold value TES, the down shift from the fifth gear to the second gear is performed by disengaging the B3 brake as well as reducing the engagement force of the C2 clutch, and then engaging the C1 clutch and the B1 brake. The down shift from the sixth gear to the third gear is performed by disengaging the B1 brake as well as reducing the engagement force of the C2 clutch, and then engaging the C1 clutch and the B3 brake. Thereby, it is possible to quickly perform the down shift from the fifth gear to the second gear or the down shift from the sixth gear to the third gear. Meanwhile, in a case where output torque TEKL of the engine is smaller than threshold value TES, the down shift from the fifth gear to the second gear is performed by disengaging the B3 while engaging the C2 clutch, and then disengaging the C2 clutch while engaging the B1 brake. The down shift from the sixth gear to the third gear is performed by disengaging the B1 brake while engaging the B3 brake, and then disengaging the C2 clutch while engaging the C1 clutch. Thereby, the down shift can be performed while continuously outputting the drive force of the vehicle.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A control apparatus for an automatic transmission connected to a power source where a gear of a first gear ratio is implemented by engaging a first engagement element and a second engagement element, a gear of a second gear ratio is implemented by engaging said second engagement element and a third engagement element, and gear of a third gear ratio is implemented by engaging said third engagement element and a fourth engagement element, comprising:
a determiner to determine whether or not a shift from said gear of said third gear ratio to said gear of said first gear ratio is to be performed;
a controller to control said automatic transmission so as to perform the shift from said gear of said third gear ratio to said gear of said first gear ratio by disengaging said fourth engagement element and said third engagement element and engaging said second engagement element and said first engagement element in a case where the shift from said gear of said third gear ratio to said gear of said first gear ratio is determined to be performed; and
a detector to detect output torque of said power source, wherein
said controller:
disengages at least one of said fourth engagement element and said third engagement element and then engages said second engagement element and said first engagement element in a case where the output torque of said power source is larger than a threshold value; and
disengages said fourth engagement element while engaging said second engagement element and then disengages said third engagement element while engaging said first engagement element in a case where the output torque of said power source is smaller than said threshold value.

2. The control apparatus for the automatic transmission according to claim 1, wherein
said controller controls said automatic transmission so as to start performing the shift from said gear of said third gear ratio to said gear of said first gear ratio when a predetermined time passes after the shift from said gear of said third gear ratio to said gear of said first gear ratio is determined to be performed.

3. The control apparatus for the automatic transmission according to claim 1, wherein
said controller disengages said fourth engagement element and then engages said second engagement element, and after said second engagement element is engaged, disengages said third engagement element as well as engages said first engagement element in the case where the output torque of said power source is larger than said threshold value.

4. The control apparatus for the automatic transmission according to claim 1, wherein
said controller disengages said fourth engagement element as well as reduces engagement force of said third engagement element, then engages said second engagement element, and after said second engagement element is engaged, disengages said third engagement element as well as engages said first engagement element in accordance with the timing when the revolution number of and input shaft of said automatic transmission is the same as the synchronous revolution number of the input shaft of said automatic transmission in said gear of said first gear ratio in the case where the output torque of said power source is larger than said threshold value.

5. A control method for an automatic transmission connected to a power source where a gear of a first gear ratio is implemented by engaging a first engagement element and a second engagement element, a gear of a second gear ratio is implemented by engaging said second engagement element and a third engagement element, and a gear of a third gear ratio is implemented by engaging said third engagement element and a fourth engagement element, comprising the steps of:
determining whether or not a shift from said gear of said third gear ratio to said gear of said first gear ratio is to be performed;
controlling said automatic transmission so as to perform the shift from said gear of said third gear ratio to said gear of said first gear ratio by disengaging said fourth engagement element and said-third engagement element and engaging said second engagement element and said first engagement element in a case where the shift from said gear of said third gear ratio to said gear of said first gear ratio is determined to be performed; and
detecting output torque of said power source, wherein
the step of controlling said automatic transmission includes the steps of:
disengaging at least one of said fourth engagement element and said third engagement element and then engaging said second engagement element and said first engagement element in a case where the output torque of said power source is larger than a threshold value; and
disengaging said fourth engagement element while engaging said second engagement element and then disengaging said third engagement element while engaging said first engagement element in a case where the output torque of said power source is smaller than said threshold value.

6. The control method for the automatic transmission according to claim 5, wherein
the step of controlling said automatic transmission includes the step of controlling said automatic transmission so as to start performing the shift from said gear of said third gear ratio to said gear of said first gear ratio when a predetermined time passes after the shift from said gear of said third gear ratio to said gear of said first gear ratio is determined to be performed.

7. The control method for the automatic transmission according to claim 5, wherein
the step of disengaging at least one of said fourth engagement element and said third engagement element and then engaging said second engagement element and said first engagement element includes the steps of:
disengaging said fourth engagement element and then engaging said second engagement element; and
after said second engagement element is engaged, disengaging said third engagement element as well as engaging said first engagement element.

8. The control method for the automatic transmission according to claim 5, wherein
the step of disengaging at least one of said fourth engagement element and said third engagement element and then engaging said second engagement element and said first engagement element includes the steps of:
disengaging said fourth engagement element as well as reducing engagement force of said third engagement element and then engaging said second engagement element; and
after said second engagement element is engaged, disengaging said third engagement element as well as engaging said first engagement element in accordance with the timing when the revolution number of an input shaft of said automatic transmission is the same as the synchronous revolution number of the input shaft of said automatic transmission in said gear of said first gear ratio.

9. A control apparatus for an automatic transmission connected to a power source where a gear of a first gear ratio is implemented by engaging a first engagement element and a second engagement element, a gear of a second gear ratio is implemented by engaging said second engagement element and a third engagement element, and a gear of a third gear ratio is implemented by engaging said third engagement element and a fourth engagement element, comprising:
means for determining whether or not a shift from said gear of said third gear ratio to said gear of said first gear ratio is performed;
control means for controlling said automatic transmission so as to perform the shift from said gear of said third gear ratio to said gear of said first gear ratio by disengaging said fourth engagement element and said third engagement element and engaging said second engagement element and said first engagement element in a case where the shift from said gear of said third gear ratio to said gear of said first gear ratio is determined to be performed; and
means for detecting output torque of said power source, wherein
said control means includes:
first shift means for disengaging at least one of said fourth engagement element and said third engagement element and then engaging said second engagement element and said first engagement element in a case where the output torque of said power source is larger than a threshold value; and
second shift means for disengaging said fourth engagement element while engaging said second engagement element and then disengaging said third engagement element while engaging said first engagement element in the case where the output torque of said power source is smaller than said threshold value.

10. The control apparatus for the automatic transmission according to claim 9, wherein
said control means includes means for controlling said automatic transmission so as to start performing the shift from said gear of said third gear ratio to said gear of said first gear ratio when a predetermined time passes after the shift from said gear of said third gear ratio to said gear of said first gear ratio is determined to be performed.

11. The control apparatus for the automatic transmission according to claim 9, wherein
said first shift means includes:
means for disengaging said fourth engagement element and then engaging said second engagement element; and
means for disengaging said third engagement element as well as engaging said first engagement element after said second engagement element is engaged.

12. The control apparatus for the automatic transmission according to claim 9, wherein
said first shift means includes:
means for disengaging said fourth engagement element as well as reducing engagement force of said third engagement element and then engaging said second engagement element; and
means for disengaging said third engagement element as well as engaging said first engagement element in accordance with the timing when the revolution number of an input shaft of said automatic transmission is the same as the synchronous revolution number of the input shaft of said automatic transmission in said gear of said first gear ratio after said second engagement element is engaged.
